(19) United States
(12) Patent Application Publication
(10) Pub. No.: US 2011/0117782 A1
(43) Pub. Date: May 19, 2011

(54) PLUG STRUCTURE WITH EASY-TO-MOUNT/REMOVE FUSE

(76) Inventor: TUN-LI SU, KAOHSIUNG COUNTY (TW)

(21) Appl. No.: 12/890,953

(22) Filed: Sep. 27, 2010

(30) Foreign Application Priority Data
Nov. 18, 2009 (TW) 098139066

(51) Int. Cl. H01R 13/68

(52) U.S. Cl. 439/620.3

(57) ABSTRACT

A plug structure includes a base having a peripheral wall. Two blades extend from the peripheral wall. The peripheral wall defines a compartment receiving front and rear clamping seats. The front and rear clamping seats releasably receives a fuse. The compartment includes an opening in communication with the outside. A lid is movably mounted to close or reveal the opening. The lid includes a fuse seat. The fuse seat releasably receives the fuse. The fuse is mountable or removable together with the lid while mounting or removing the lid into or from the opening.

### BACKGROUND OF THE INVENTION

The present invention relates to a plug structure with an easy-to-mount/remove fuse and, more particularly, to a plug structure with a fuse that can be easily mounted and removed together with a lid of a base.

An AC power source for electric appliances or electronic devices used in daily life and industries is generally supplied to the electric appliances or electronic devices through use of a plug and a socket to conduct electric current. A typical plug generally includes two blades and an optional grounding blade. For safety consideration, a type of the plug receives a fuse that melts and breaks to form an open circuit when overload current occurs. Current fuses are generally cylindrical and, thus, dubbed as “fuse cylinders”.

The fuse is received in a compartment of a base of a plug and clamped by front and rear resilient clamping seats in the compartment to allow easy mounting and removal. When the fuse is burnt or malfunctions and, thus, must be replaced, a lid of the base is removed to allow access to the fuse for replacement. However, the lid and the fuse must be detached separately, leading to inconvenient use.

### BRIEF SUMMARY OF THE INVENTION

In view of the disadvantages of the prior art, the present invention provides a plug structure having a fuse that can easily be mounted and removed. The plug structure according to the preferred teachings of the present invention includes a base having a peripheral wall. Two blades extend from the peripheral wall. The peripheral wall defines a compartment receiving front and rear clamping seats. The front and rear clamping seats is adapted to releasably receive a fuse. The compartment includes an opening in communication with the outside. A lid is movably mounted to close or reveal the opening. The lid includes a fuse seat. The fuse seat is adapted to releasably receive the fuse. The fuse is mountable or removable together with the lid while mounting or removing the lid into or from the opening.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a plug structure of a first embodiment according to the preferred teachings of the present invention.

FIG. 2 shows an exploded, perspective view of the plug structure of FIG. 1.

FIG. 3 shows a cross sectional view of the plug structure of FIG. 1.

FIG. 4 shows a cross sectional view of the plug structure of FIG. 3 with a lid moved forward.

FIG. 5 shows a cross sectional view of the plug structure of FIG. 4 with the lid pivoted away from a base of the plug structure.

FIG. 6 shows a perspective view of a final product of the plug structure of FIG. 1.

FIG. 7 shows a perspective view of a plug structure of a second embodiment according to the preferred teachings of the present invention.

FIG. 8 shows an exploded, perspective view of the plug structure of FIG. 7.

FIG. 9 shows a perspective view of the plug structure with a section of each of two blades of the plug structure covered with an insulating layer.

FIG. 10 shows a perspective view of a plug structure modified from the plug structure of FIG. 1 with the blades having differing widths.

FIG. 11 shows a perspective view of a plug structure according to the preferred teachings of the present invention having a side clamping seat for receiving a blade.

### DETAILED DESCRIPTION OF THE INVENTION

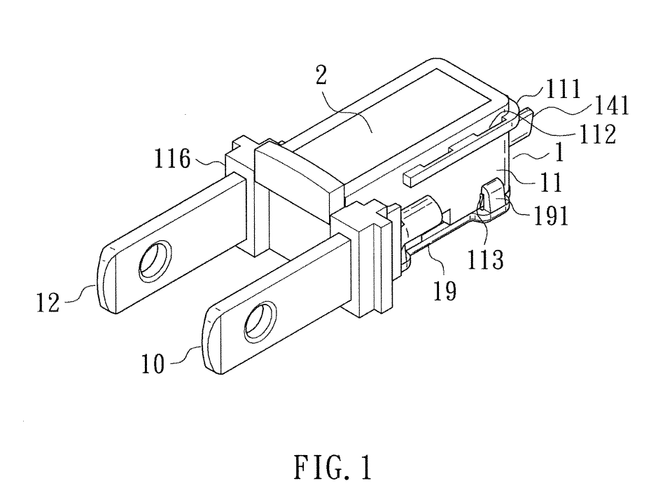

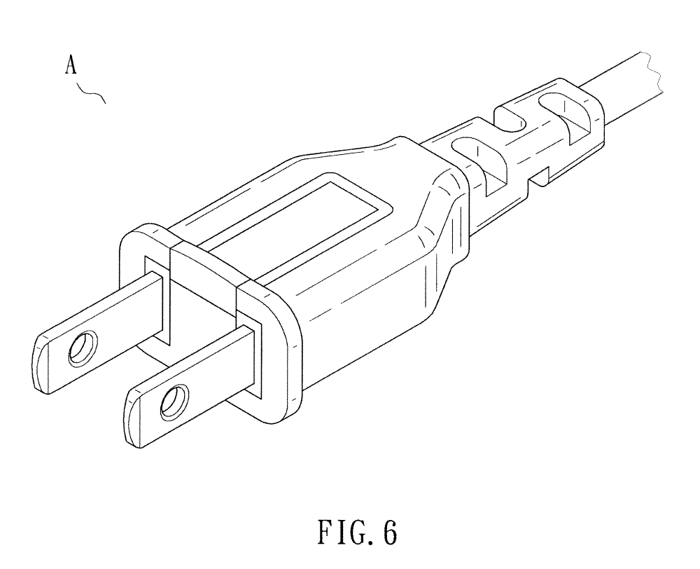

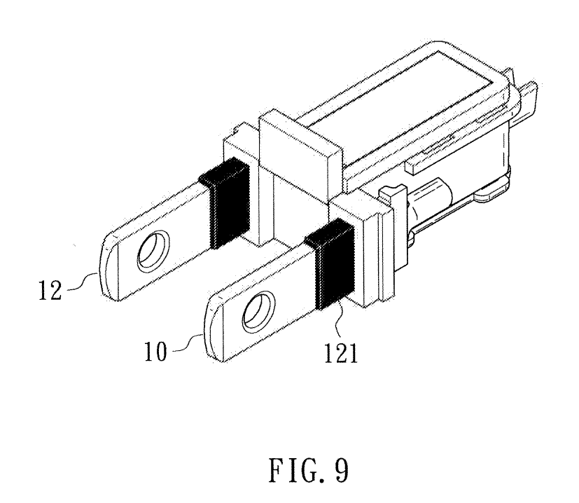

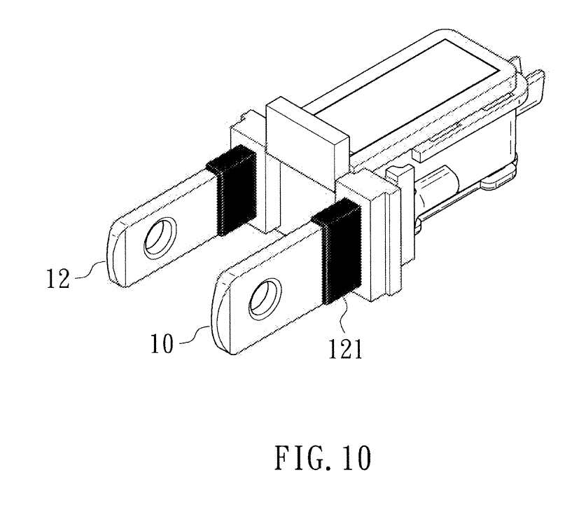

With reference to FIGS. 1, 2, and 6, a plug structure of a first embodiment according to the preferred teachings of the present invention generally includes a base 1 and a lid 2. The base 1 includes a peripheral wall 11 from which two blades 12 and 10 extend. A section of each blade 12, 10 adjacent to a root of the blade 12, 10 can be covered by an insulating layer, as shown in FIG. 9. Alternatively, the blades 12 and 10 can have different widths according to differing polarities, as shown in FIG. 10. A compartment P is defined by the peripheral wall 11 of the base 1. Front and rear clamping seats 13 and 14 are provided in the compartment P. The compartment P has an opening 15 in communication with the outside.

The lid 2 includes a fuse seat 21 for releasably receiving a fuse 3. The fuse seat 21 can be in the form of a hollow cylinder 210 having a hole 211. The fuse 3 can be inserted into or removed from the hole 211. The lid 2 is mounted to the opening 15 and can be moved to a position to reveal the opening 15. The fuse 3 melts and breaks to form an open circuit when overload current occurs, protecting the circuits. The fuse 3 is substantially cylindrical and includes two electrically conductive sections 31 and 32. In use, the fuse 3 is received in compartment Pond resiliently and releasably clamped by the front and rear clamping seats 13 and 14 at the electrically conductive section 31 and 32 to allow easy insertion and removal of the fuse 3. Thus, the lid 2 provides a fuse seat 21 for the fuse 3 such that the fuse 3 can be easily mounted and removed together with the lid 2 while mounting or removing the lid 2 into or from the opening 15.

In the first embodiment, the opening 15 is formed in an outer side of the base 1. The term “outer side” relates to the exposed side of the base 1 outside of the area between the blades 12 and 10. The term “inner side” relates to the end face of the base 1 between the blades 12 and 10.

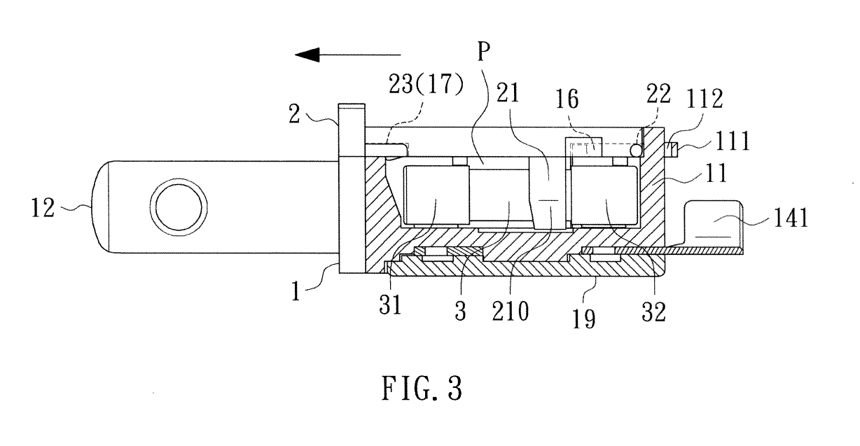

The opening 15 includes front and rear ends. Unless indicated otherwise, the rear end of the opening 15 is the end opposite to the free ends of the blades 12 and 10, and the front end of the opening 15 is the end facing the free ends of the blades 12 and 10. A first track 16 is formed in each of two inner sides of the opening 15 adjacent to the rear end of the opening 15, as shown in FIGS. 3-5. The lid 2 includes a protrusion 22 on each of two lateral sides thereof. In this embodiment, a spacing between outer ends of the protrusions 22 is slightly larger than a width of the opening 15 and smaller than a spacing between two inner lateral edges respectively of the first tracks 16. Furthermore, the protrusions 22 are respectively and slideably received in the first tracks 16.

When inserting the protrusions 22 into the first tracks 16, the lid 2 is slightly turned with each protrusions 22 aligned with the first tracks 16. The lid 2 is then turned back.

In order to provide reliable engagement while the lid 2 is mounted to the lid 2, the lid 2 includes an engaging member 23 on each lateral side adjacent to the front end. The opening 15 includes a second track 17 in the front end of each of the inner sides of the opening 15. The engaging members 23 of the lid 2 slide into the second tracks 17 while the protrusions 22 are inserted into the first tracks 16.

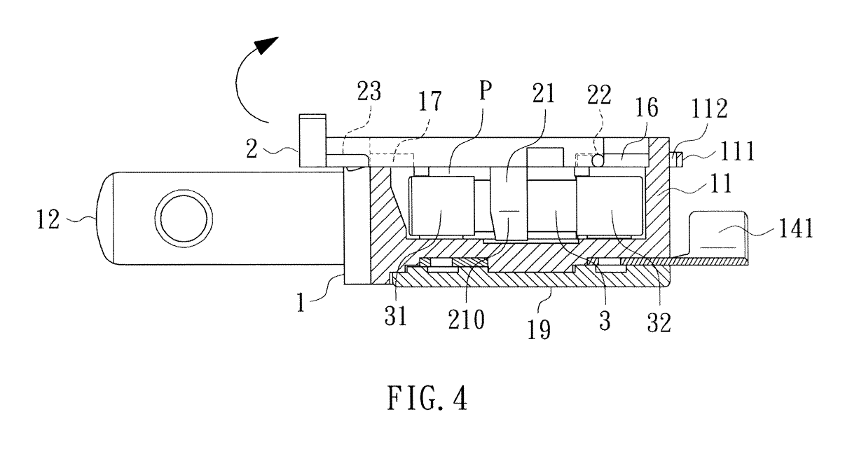

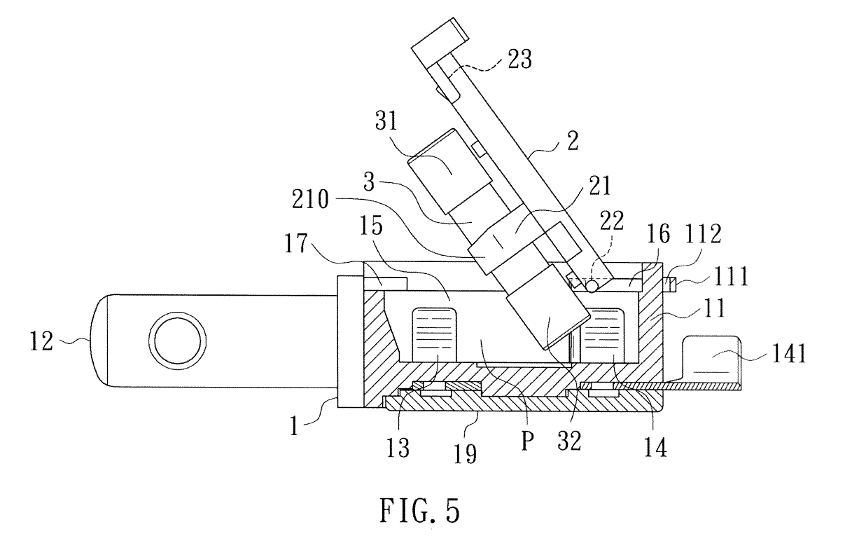

With reference to FIG. 3, when it is desired to remove the fuse 3, the lid 2 is moved forward (i.e., leftward in FIG. 3) to a position shown in FIG. 4. The engaging members 23 are moved out of the second tracks 27. The front end of the lid 2 is then pivoted away from the base 1 with the protrusions 22 acting as pivots, as shown in FIG. 5. The fuse 3 mounted to the lid 2 is disengaged from the front and rear clamping seats 13 and 14 while the lid 2 is pivoted away from the base 1. The fuse 3 is, thus, exposed to allow easy removal.

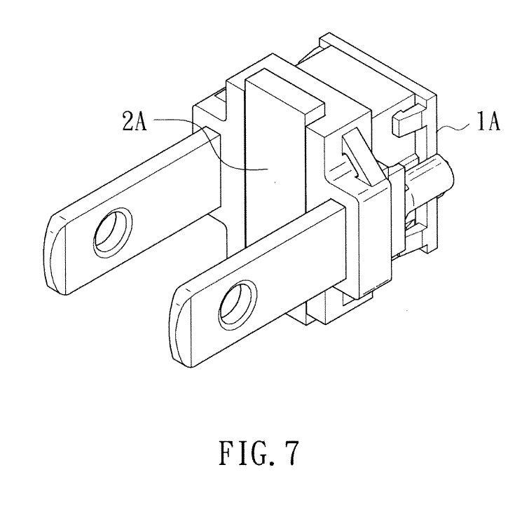

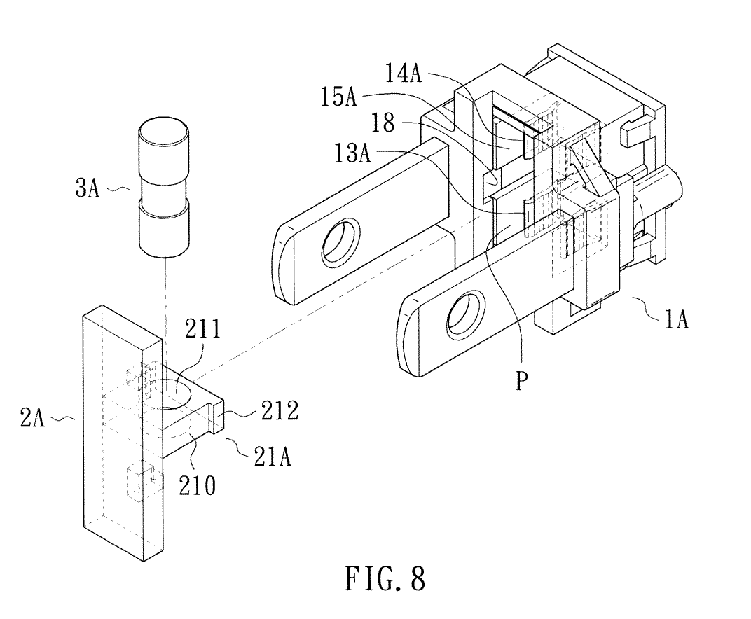

FIGS. 7 and 8 show another embodiment of the present invention. The opening 15A is defined in the inner side of the base 1 between the blades 12 and 10, providing a simplified structure. The lid 2A is engaged with an inner edge of the opening 15A. The lid 2A includes a fuse seat 21A for releasably receiving a fuse 3A. The fuse seat 21A is in the form of a hollow cylinder 210 having a hole 211. The fuse 3A can be inserted into or removed from the hole 211. The lid 2A is mounted to the opening 15 and can be moved to a position to reveal the opening 15A. In use, the fuse 3A is received in compartment P and resiliently and releasably clamped by the front and rear clamping seats 13A and 14A to allow easy insertion and removal of the fuse 3.

In this embodiment, only detachment of the lid 2A from the inner side of the base 1A is required. Since the lid 2A provides a fuse seat 21A for the fuse 3A, the fuse 3 can be easily mounted and removed together with the lid 2 while mounting or removing the lid 2 into or from the opening 15A. The lid 2A can further include a hook 212 on each of two lateral sides of the fuse seat 21A. The base 1A includes an engaging groove 18 in each of two inner sides of the opening 15A. When the fuse seat 21A and the fuse 3A are exposed while the lid 2A is moved to a position revealing the opening 15A, the hooks 212 located on the lateral sides of the fuse seat 21A engage with the sides of the engaging grooves 18 to prevent the lid 2A from disengaging from the opening 15A.

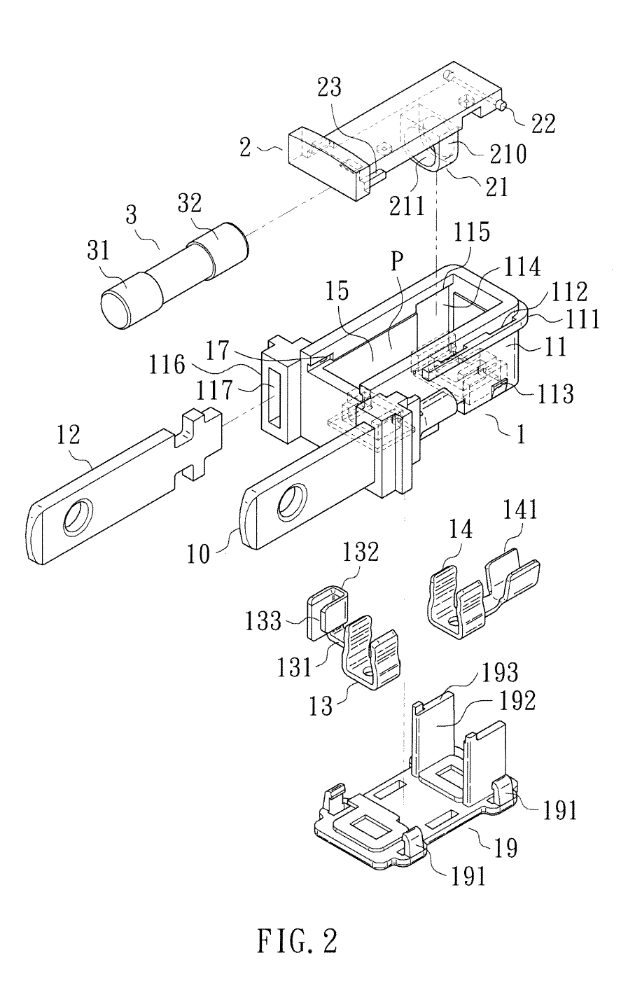

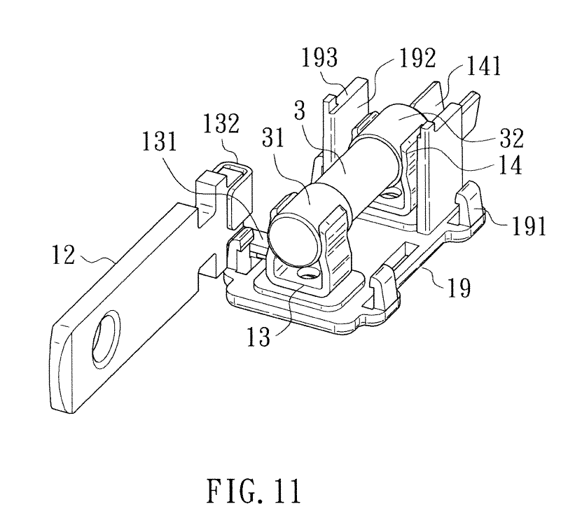

With reference to FIGS. 2 and 11, the front clamping seat 13 can include a side clamping seat 132 extending from a connecting plate 131 that extends from a side of the front clamping seat 13. The side clamping seat 132 includes a holding gap 133. Thus, the blade 12 can be easily inserted into and clamped in the holding gap 133 or removed from the holding gap 133 for replacement. To allow reliable insertion of the blade 12, the peripheral wall 11 includes a frame 116 at the front end of one of the lateral sides thereof. The frame 116 is located in front of the side clamping seat 132 and has a frame hole 117 aligned with the clamping gap 133. The blade 12 is securely held by the frame 116 before the blade 12 is inserted into the clamping gap 133 of the side clamping seat 131.

With regard to the rear clamping seat 14, a wire-riveting plate 141 extend integrally from the rear clamping seat 14 to allow easy installation without the need of additional riveting.

With reference to FIG. 2, a U-shaped rib 111 is formed an outer surface of the peripheral wall 11 with a gap 112 formed between the peripheral wall 11 and the rib 111. The gap 112 can receive molten plastic material during injection molding of the plastic material to surround the peripheral wall 11. The plastic material envelopes and is fixed together with the rib 111 after the plastic material cures, preventing the plastic material from disengaging from the peripheral wall 11 during curing of the plastic material.

With reference to FIG. 2, to allow easy assembly, a bottom cap 19 is mounted to a lower side of the compartment P. To provide sealing between the bottom cap 19 and the peripheral wall P for the purposes of reducing the risk of entrance of the molten plastic material into the compartment P during injection molding, the bottom cap 19 includes a hook 191 on each of two sides thereof, and the peripheral wall 11 includes an engaging plate 113 on each of the lateral sides thereof for engagement with the hooks 191 of the bottom cap 19. The number of the hooks 191 can be varied according to needs, and the number of the engaging plates 113 corresponds to that of the hooks 191. Furthermore, the bottom cap 19 includes aside plate 192 extending upward from each of the sides thereof. Each side plate 192 includes a recessed portion 193. The peripheral wall 11 includes two grooves 114 in the inner side thereof. The grooves 14 are aligned with the side plates 192. Each recessed portion 192 and a top edge 115 of one of the grooves 114 together form one of the first track 16.

Although specific embodiments have been illustrated and described, numerous modifications and variations are still possible without departing from the essence of the invention. The scope of the invention is limited by the accompanying claims.

1. A plug structure comprising:
a base including a peripheral wall, with two blades extending from the peripheral wall, with the peripheral wall defining a compartment receiving front and rear clamping seats, with the front and rear clamping seats adapted to releasably receive a fuse, with the compartment including an opening in communication with an outside; and
a lid movably mounted to close or reveal the opening, the lid including a fuse seat, with the fuse seat adapted to releasably receive the fuse, with the fuse mountable or removable together with the lid while mounting or removing the lid into or from the opening.

2. The plug structure as claimed in claim 1, with a first track formed in each of two inner sides of the opening adjacent to a rear end of the opening, with the lid including a protrusion on each of two lateral sides thereof, with a spacing between outer ends of the protrusions slightly larger than a width of the opening and smaller than a spacing between two inner lateral edges respectively of the first tracks, with the protrusions slideably received in the first tracks.

3. The plug structure as claimed in claim 2, with the lid including an engaging member on each of the two lateral sides adjacent to a front end thereof, with the opening including a second track in a front end of each of the two inner sides of the opening, with the engaging members of the lid sliding into the second tracks while the protrusions are inserted into the first tracks.

4. The plug structure as claimed in claim 1, with the opening formed in an inner side of the base, with the lid mounted in the opening and engaged with an inner edge of the opening.

5. The plug structure as claimed in claim 1, with the fuse seat including a hollow cylinder having a hole, with the hole adapted to releasably receive the fuse.

6. The plug structure as claimed in claim 1, with the lid further including a hook on each of two lateral sides of the fuse seat, with the base including an engaging groove in each of two inner sides of the opening, with the hooks of the lid engaged with the engaging grooves of the base while the lid is moved to a position revealing the opening for access to the fuse.

7. The plug structure as claimed in claim 1, with the front clamping seat including a side clamping seat extending from a side of the front clamping seat, with the side clamping seat including a holding gap, with the holding gap holding one of the blades.

8. The plug structure as claimed in claim 1, with a rib formed on an outer surface of the peripheral wall, with a gap formed between the rib and the peripheral wall.

9. The plug structure as claimed in claim 1, further comprising: a bottom cap mounted to a lower side of the opening, with the bottom cap including a hook on each of two sides thereof, with the peripheral wall including an engaging plate on each of two lateral sides thereof, with the engaging plates engaged with the hooks.

10. The plug structure as claimed in claim 1, further comprising: a wire-riveting plate extending integrally from the rear clamping seat.
